(19) United States
(12) Patent Application Publication
(10) Pub. No.: US 2005/0181245 A1
(43) Pub. Date: Aug. 18, 2005

(54) HYDROGEN AND ELECTRICAL POWER GENERATOR

(75) Inventors: Ulrich Bonne, Hopkins, MN (US); Roland A. Wood, Bloomington, MN (US); Steven J. Eickhoff, Plymouth, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 10/907,294

(22) Filed: Mar. 28, 2005

Related U.S. Application Data
(63) Continuation-in-part of application No. 10/750,581, filed on Dec. 29, 2003.

(51) Int. Cl. H01M 8/00

(52) U.S. Cl. 429/12

(57) ABSTRACT

A device using needed hydrogen gas flow and electricity for operation obtained from a fuel cell power supply. Also, water generated by the fuel cell may be recycled for hydrogen generation which may be used by the device and in turn expanded by the fuel cell for further electrical power generation. The device may be a gas chromatograph, a fluid calibration mechanism, a flame ionization detector, or the like.

This application is a continuation-in-part of and claims the benefit of U.S. patent application Ser. No. 10/750,581, filed Dec. 29, 2003, entitled “Micro Fuel Cell”, which is incorporated herein by reference.

The invention may be related to U.S. Pat. No. 6,393,894 B1, issued May 28, 2002, and entitled, “Gas Sensor with Phased Heaters for Increased Sensitivity”, which is incorporated herein by reference.

### BACKGROUND

The invention pertains to hydrogen gas generation for usage by a device, and particularly to both hydrogen and electrical power generation for the device.

### Summary

The present invention relates to hydrogen and electrical power generation for devices that use both hydrogen and electrical power for operation. Further, a by-product of power generation may be recycled for further hydrogen and power generation.

### BRIEF DESCRIPTION OF THE DRAWING

FIG. 1 is a diagram of a hydrogen gas and electrical power generator integrated with a device, such as a fluid chromatograph, that uses both the gas and power;

FIG. 2 is similar to FIG. 1 except that the device is a chromatograph with a preconcentrator and has electrical power storage;

FIG. 3 reveals another configuration of a hydrogen and electrical power generator;

FIG. 4 shows a fluid analyzer that may be used in conjunction with the present generator;

FIGS. 5 and 6 are two views of the heater arrangement for the fluid analyzer; and

FIG. 7 shows a micro gas analyzer that may have a hydrogen and power generator structurally integrated within the analyzer.

### DESCRIPTION

There may be battery powered devices that need H₂ gas flow and power for their operation, such as a field-portable FID (i.e., a H₂-flame ionization detector), whether as a stand-alone portable FID or as part of a GC (gas chromatograph) detector to scan for natural gas leaks, and a micro GC. These devices may have an H₂ or H₂-N₂ gas tank strapped to one side, which is generally bulky and heavy, which needs to be replaced or re-filled periodically, and which may accrue demurrage charges. Additionally, the portable devices may use heavy batteries, which can render the 8-hour leak-detection work shift with such instruments somewhat tiresome.

The present invention may provide a better source for H₂ in a form of a special H₂ fuel cell. This cell may be more compact (i.e., having higher energy density), have an absence of the heavy pressurized steel tanks, generate electrical power besides H₂ , store such power for an ease of cold starts, or peak power needs, and thus obviate a need for heavy 8-hour batteries. The generator may recycle the water it generates.

The present generator may provide H₂ for a fuel cell. The generator may convert 1.4 cm³ of LiAlH₄ and 1.6 cm³ of H₂O to 2000 cm³ of H₂. This converting may be expressed chemically as
LiAlH₄+4 H₂O>>4H₂+Al(OH)₃+LiOH(1)ΔH(form.) in kJ/mol:
−117.2−4×285.83>>0−1273−487−19.2=−518.7 kJ.

This H₂ may then generate about 128 Wh of electrical energy in a fuel cell. The fuel cell may have an energy density that is 1.5 to 2 times higher than presently available commercial lithium batteries. An example lithium battery may be similar in size to a “C-cell” battery. Such C-cell battery may be a Tekcell™ CR123A 3 volt battery having a 1.7 cm diameter, 3.5 cm length, at about 8 cm³ and 17 grams. The power output may be about 4.2 Wh or 0.48 mW for a year. A larger battery capable of a power draw of about ten watts would have a size of about 300 cm³. There may be a fuel cell battery designed for an average power draw of 2 milliamps (mA) which is an equivalent to a power of 0.6 V×2 mA=1.2 mW (milliwatts).

For an illustrative example, the hydrogen and power needs of a micro gas analyzer may be about 3 cm³ per minute, which may lead to 2000 cm³ to last for about 650 minutes, which may exceed a goal of operating the micro gas analyzer with no more than an average of 0.25 W. The power equivalent to about 3 cm³/minute may be stated as the following equivalency. One Faraday (96,500 Cb) corresponds to 1 mole, so that one may equate (96500 Cb×3 V) to 22,415 cm³, that is, 3cm³/minute is equivalent to (3/22415)(96500*3/60)=0.646 W.

The micro fuel cell may allow the chemical fuel to react with the natural water diffusing from the water, since it does not need a liquid pump in the generator. This device may produce about 0.1 cm³/minute of H₂. To generate 3 cm³/minute of H₂, they would need to transfer the water 30 times faster. This might be possible using a natural diffusion of water vapor, if a Gore-Tex™ membrane in the cell is increased to an area of about 2″×2″. Or one may include a water pump. The water pumping rate may need to be about 4×10⁻⁵ cm³/second.

Another challenge to overcome for conserving energy is to let the generated H₂ adopt the function of the H₂ carrier gas pump and replace the pump. If air samples need to be analyzed and its target analytes need to be preconcentrated, at least the separation can then be made in a H₂-carrier gas, after the sample is injected into the H₂ gas stream. An advantageous aspect may be that the generator can generate H₂ under pressure. Another aspect may be that the fuel cell can draw H₂ against a vacuum, by virtue of its affinity to react with O₂ from the air to form water, which upon condensation may reduce the absolute pressure in the fuel cell a little due to the volume reduction resulting from the following reaction.
2H₂+O₂+4.83N₂>>2H₂O(liq)+4.83N₂.

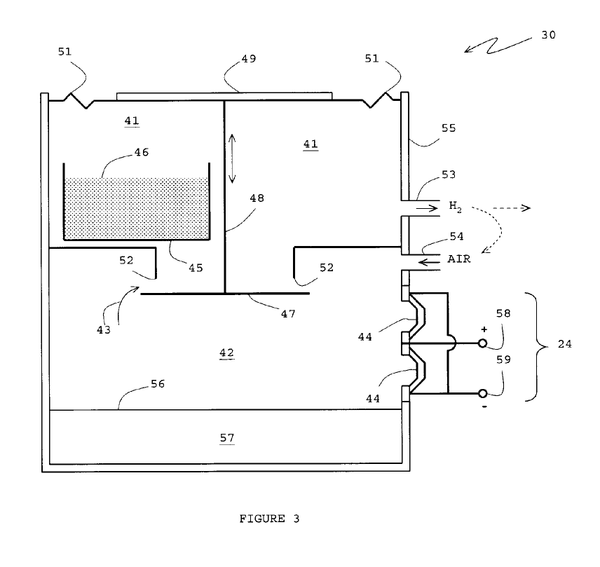

This reaction may amount to a volumetric reduction to about 4.83/7.83=0.617 of the original volume or pressure. This assumes that the H₂ fuel cell can facilitate the above reaction against such a pressure difference. The present H₂ generation rates may be only limited by the rate of permeation of water (liquid or gas) through the shown Gore-Tex™ membranes which can result in a continuous but uncontrolled H₂ and power generation, especially if there are leaks in the pneumatic valve that controls the water supply rate to the H₂ generator, as shown in FIG. 3.

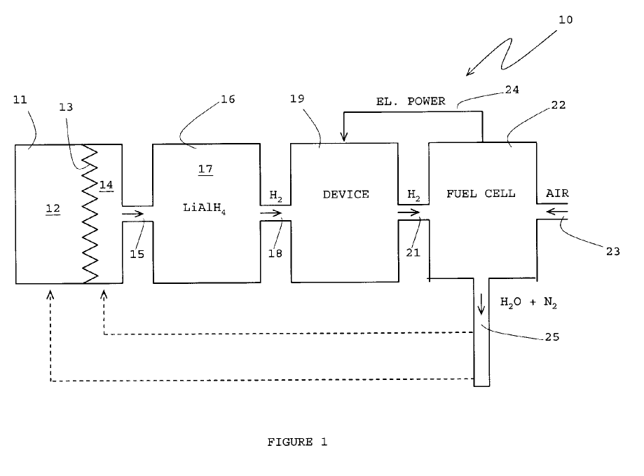

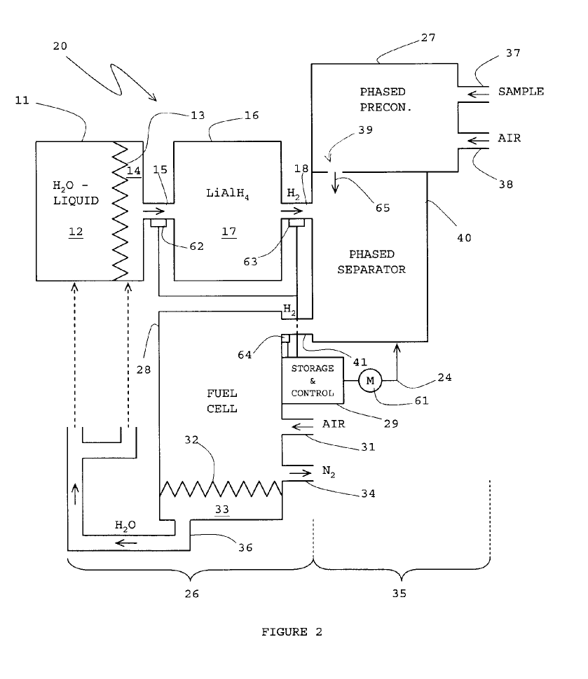

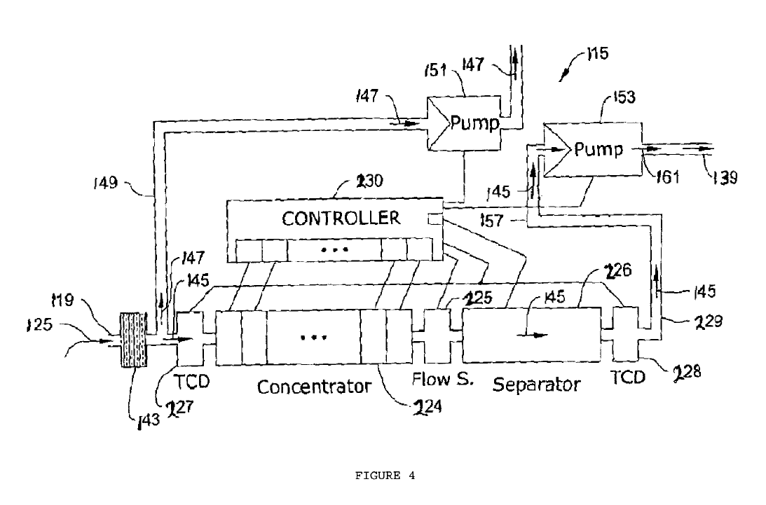

The generator system may have the building blocks of FIGS. 1 and 2, to operate a device such as a GC of FID, or any other device having a need of both H₂ and electrical power. FIG. 4 shows an illustrative example of a micro GC that may utilize H₂ and electrical power. The brackets 26 and 35 in FIG. 2 show the H₂ and power generator, and the device to be electrically powered and supplied with H₂, respectively. The non-disposable or non-rechargeable parts may be incorporated in the device package, such as the electric energy storage device, which might not be part of the generator package. A similar box may be drawn for the power-generation controls, so that no power would be generated when the storage is full and the device does not need it.

The sensor system may have a disposable (or rechargeable) “battery” or generator, which generates and provides H₂ to separate “devices”, before this H₂ is returned and used in the generator to also generate electric power via known H₂ fuel cell technology. A hydrogen gas generator may supply the H₂ and electrical power needs of a device such as an FID and/or micro gas analyzer or a gas calibration system. The gas generator may employ hydrogen-containing chemicals. The hydrogen-containing chemicals may be water and a metal hydride. In a combination of the generator and device, the device may make a non-destructive use of the generated H₂ before returning it to the generator. In the generator, the returned hydrogen may be passed to a fuel cell to generate electrical power. The generated electrical power may be stored in a storage device, which may be one or more of the following, including a capacitor, a super capacitor and a rechargeable battery. The water generated in the fuel cell may be recycled to the hydrogen generator to make more hydrogen, and thus reduce the water storage weight and volume. The control of hydrogen flow and pressure may be regulated based on the power drawn by the device. The excess power generated with the needed use of hydrogen may be stored. Such power may be used for data processing, wireless transmission, and/or heating/annealing/regeneration of appropriate device parts, while the hydrogen flow is not needed.

The advantages of the generator-device system may include a disposable or rechargeable “battery” that generates both H₂ and electrical power. The system may provide for reduced space, weight and total power consumption, which are premium advantages for portable devices. An energy storage of the system may enable sensor start-up during generator delays, reduced generator power waste when H₂ needs exceed the associated power generation, and data processing and transmission without H₂ flow. Also, in the system, recycling the water from the fuel cell back to the H₂ generation block may reduce weight and volume for H₂O storage.

FIG. 1 is a diagram of a generator 10 for a device that has a need for H₂ and electrical power. An example device 19 may be a (PHASED) micro GC system. The first block 11 may contain a volume 12 for containing an H₂O liquid. Across the block 11 containing volume 12 may be a Gore-Tex™ membrane 13 or equivalent material, and a volume 14 on the other side of membrane 13 opposite of volume 12. In volume 14 may be H₂O vapor which may flow through a passage 15 into a block 16 having a volume 17 containing LiAlH4. A chemical reaction between the H₂O vapor and LiAlH4 may result in an H₂ gas (and by-products Al(OH)₃ and LiOH(1). From block 16, the H₂ gas may flow through a passage 18 onto a device 19 which may utilize the H₂ gas and electrical power. From device 19, H₂ gas may flow to a fuel cell 22 via a passage 21. Air maybe brought into the fuel cell 22 through a passage 23. The fuel cell, as a result from these ingredients, may produce electrical power 24 to be sent to device 19 to operate it. A by-product of the fuel cell 22 reaction may be H₂O and N₂. The H₂O may condense to a liquid and be fed via a tube 25 into volume 12 of block 11, which in turn may result in a process of going through the membrane to form H₂O vapor, as noted above. H₂O from the fuel cell 22 may be fed directly to volume 14 of block 13.

FIG. 2 shows another diagram of a system 20 having an H₂ gas and electric power generator 25 with H₂O reuse, to drive a PHASED micro GC 40 with a preconcentrator 27. Blocks 11 and 16 may operate in a similar fashion as those blocks of system 10 of FIG. 1. Fuel call 28 is similar to fuel cell 22, however, it has an output into a storage and control box 29 which may provide for energy storage from fuel cell 28 and power controls, so that no power would be generated when the storage is full and a device 35 connected to it does not need power at that time. Power 24 may go from the storage and control box 29 to the PHASED micro gas analyzer 40. Air may enter fuel cell 28 via passage 31. There may be a Gore-Tex™ membrane 32 to separate the by-products H₂O and N₂ from the fuel cell reaction so that the H₂O may enter volume 33 and N₂ may exit fuel cell 28 via passage 34. H₂O may exit fuel cell 28 via passage 36 and go to block 11 with the liquid H₂O to volume 12 and the H₂O vapor to volume 14.

Device 35 may consist of a preconcentrator 27 and the phased heater micro gas analyzer 40. A sample and air may enter preconcentrator 27 via passages 37 and 38, respectively. The preconditioned sample 65 may be injected or go from preconditioner 27 to gas analyzer 40 via an orifice 39. Analyzer 40 may obtain H₂ gas from the chemical reaction in block 16 producing H₂, via the passage 18. Analyzer 40 may utilize the H₂ as a carrier gas in its process and then pass on H₂ gas to fuel cell 28 via passage 41 where cell 28 may utilize it in the reaction to generate more electrical energy as needed.

In FIG. 2, there may also be a meter 61 at the output of fuel cell 28 and/or storage control box 29 for measuring power, and connected to the storage and control box 29. There may be pressure sensors, flow sensors and/or valves 62, 63 and 64 situated at passages 15, 18 and 41, respectively, and connected to the storage and control box 29. With inputs to and outputs from between the sensors and valves and the storage and control box, such things as the control of hydrogen flow and pressure may be regulated based on the power drawn from the fuel cell 22 by the analyzer 40, data processing, wireless transmission and/or heating, annealing/regeneration or appropriate devices and/or mechanisms and their parts, and so on.

FIG. 3 shows a schematic view of an H₂ generator combination 30 based on LiAlH₄ from fuel chamber 41, a hydrogen and water chamber 42 and associated fuel cells 44. Fuel chamber 41 may have a container 45 of a fuel 46 and residue. The fuel 46 may include LiAlH₄ which may be combined with water vapor 43 to form H₂ in chamber 41 as permitted by valve plate 47 which may be actuated into an open position by a connecting node 48 moved by a diaphragm 49. Diaphragm 49 may be attached to a flexible but air-tight membrane 51 which permits the movement of diaphragm 49 which opens or closes the valve plate 47 relative to a valve seat 52 as needed for providing H₂ to the fuel cells 44 to output electrical power. H₂ may be provided also from chamber 41 via a passage 53. Air may be provided to chamber 42 for the fuel cells 44 via a passage 54. Power 24 may come from fuel cells 44. The valve plate 47 and seat 52 may form a normally closed or open valve depending ultimately on the need of power 24 from fuel cells 44. Diaphragm 49 may actuate valve plate 47 with a differential pressure external and internal to membrane 51 of container 55 which may be dependent on closure of passages 53 and/or 54. Chamber 42 may have a Gore-Tex™ membrane 56 attached across the bottom portion of container 55 to form a volume 57 which may contain water. The membrane 56 may permit a movement of vapor from volume 57 into volumes 42 and 41. Fuel cells may output a voltage across terminals 58 and 59 to provide the electrical power 24.

FIG. 4 reveals certain aspects of a micro gas apparatus 115. The apparatus 11 5 may be a fluid composition sensor, analyzer or chromatograph, and have a concentrator 224, separator 226, various detectors 227, 225, 228 and a pump 151, 153. The concentrator may have an array of “phased” heaters that are turned on at different times relative to each other in a fluid stream channel. The apparatus 115 may relate to a phased heater array structure, and to application of the structure as a sensor, analyzer or chromatograph for the identification and quantification of fluid components. Such apparatus 115 having such a (phased) heater configuration may be regarded as or referred to as a “PHASED” device. The term “PHASED” also may be regarded as an acronym referring to “Phased Heater Array Structure for Enhanced Detection”.

Sample stream 125 may enter an input from pipe or tube 119, to apparatus 115, as shown in FIG. 4. There may be a particle filter 143 for removing dirt and other particles from the stream of fluid 125 that is to enter apparatus 115. A portion 145 of fluid 125 may flow through the first leg of a differential thermal-conductivity detector (TCD), or chemi-sensor (CRD), or photo-ionization sensor/detector (PID), or other device) 227 which may measure photo-ionization current, and a portion 147 of fluid 125 flows through tube 149 to a pump 151. By placing a “T” tube immediately adjacent to the inlet of detector 227,sampling with minimal time delay may be achieved because of the relatively higher flow 147 to help shorten the filter purge time. Pump 151 may cause fluid 147 to flow from the output of particle filter 143 through tube 149 and exit from pump 151. Pump 153 may effect a flow of fluid 145 through the sensor via tube 157. There may be additional or one pump, and various tube or plumbing arrangements or configurations for system 115 in FIG. 4. Hydrogen may act as a carrier of a sample in fluid 145.

Fluid 1 45 may proceed through a concentrator 224, through a flow sensor 225, and a separator 226. From separator 226, fluid 145 may go through sensor or detector 228 and exit tube 229 which may be connected to tube 157 and pump 153. Fluid 145 may exit pump 153. Concentrator 224 may have heaters that are turned on sequentially as flow 145 moves by them at the same rate or speed of the heaters being turned on so that a heat pulse builds up in the fluid 145. The heat pulse may move through channel 132 of concentrator 224 at the same rate of or in phase with the fluid 145 in a flow through the channel. As the concentrated fluid 145 goes through separator 226, it may be heated for separation purposes. The heaters may be regarded as phased heaters. A controller 230 may be connected to a concentrator 224 to control the phasing of the heating of the elements 120,122, . . . 124 and 126, for providing a concentrated heat pulse in the flow of fluid 145. Controller 230 may also be connected to separator 226, sensors and/or detectors 227, 225 and 228. Controller 230 may be connected to pumps 151 and 153. Data from detectors 225, 227 and 228 may be sent to controller 230 for processing.

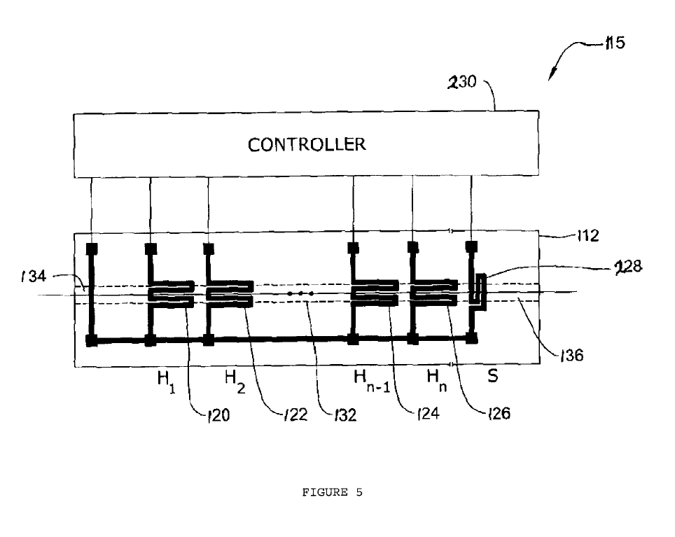

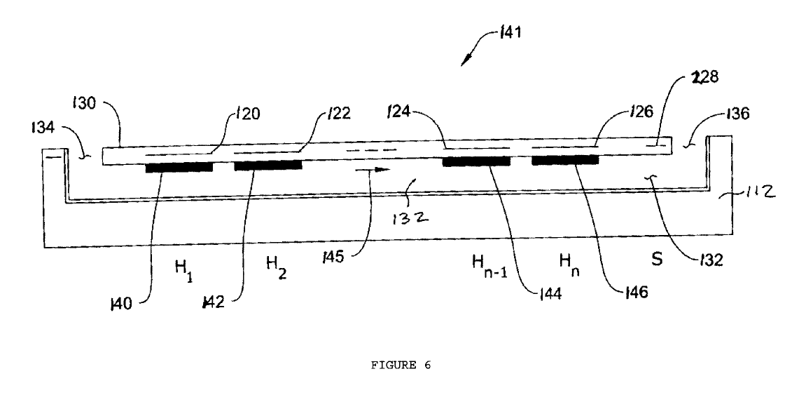

FIG. 5 is a schematic diagram of part of the sensor apparatus 115, representing a portion of concentrator 224 or separator 226 in FIG. 4. The sensor apparatus may include a substrate 112 and a controller 230. Controller 230 may or may not be incorporated into substrate 112. Substrate 112 may have a number of thin film heater elements 120, 122, 124, and 126 positioned thereon. While only four heater elements are shown, any number of heater elements may be provided, for instance, between two and one thousand, but typically in the 20-100 range. Heater elements 120, 122, 124, and 126 may be fabricated of any suitable electrical conductor, stable metal, or alloy film, such as a nickel-iron alloy. Heater elements 120, 122, 124, and 126 may be provided on a thin, low-thermal mass, low-in-plane thermal conduction, support member 130, as shown in FIG. 6. Support member or membrane 130 may be made from Si₃N₄ or other appropriate or like material. The heater elements may be made from Pt or other appropriate or like material.

Substrate 112 may have a well-defined single-channel phased heater mechanism 141 having a channel 132 for receiving the sample fluid stream 145, as shown in FIG. 6. Substrate 112 may have a defined channel 132 for receiving a streaming sample fluid 145. The channel may be fabricated by selectively etching silicon channel wafer substrate 112 beneath support member 130. The channel 132 may include an entry port 134 and an exhaust port 136.

The sensor apparatus may also include a number of interactive elements inside channel 132 so that they are exposed to the streaming sample fluid 145. Each of the interactive elements may be positioned adjacent, i.e., for closest possible contact, to a corresponding heater element. For example, in FIG. 6, interactive elements 140, 142, 144, and 146 may be provided on the lower surface of support member 130 in channel 132, and be adjacent to heater elements 120, 122, 124, and 126, respectively. There may be other channels with additional interactive film elements which are not shown in the present illustrative example. The interactive elements may be formed from any number of films commonly used in liquid or gas chromatography.

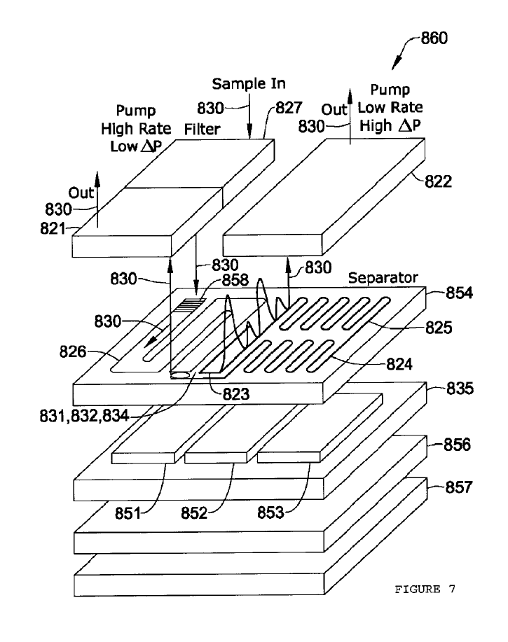

FIG. 7 shows an expanded perspective of a micro analyzer 800. Analyzer 800 may have a channel and a series of heaters situated along the channel. The heaters may turn on in a sequential manner to continually heat a portion of a sample fluid as it moves through the channel. The heaters may provide a heat pulse that moves along the channel at a velocity about the same as a velocity of the portion of the sample fluid moving through the channel. The heaters may cumulatively heat the portion of the sample fluid. There may be a preconcentrator connected to the fluid analyzer.

The lateral dimensions of the package or module 860 of the analyzer 800 may be about 2 cm by 1.3 cm. Module 860 may be a stack of wafers or chips. The vertical dimension of the package may be about 0.7 cm for a volume of about 1.8 cm³. The lower portion of the module 860 may be controller 835 that contains a control electronics 851 chip, a data acquisition and analysis 852 chip and a high frequency drive electronics 853 chip. The lower portion may have a thickness of about 3 millimeters. A middle portion 854 may include pre-concentrator 826, concentrator 823, first separator 824, second separator 825, instrumentation 831, 832 and 834, and at least one channel and the phased heaters 20, 22, 24, . . . , 26. Portion or wafer 854 may or may not include the ITMS 849. Spectrometer 849 may be on a separate chip or stack of chips. The middle portion 854 may have a thickness of about one millimeter. The top portion may contain the first pump 821, second pump 822 and filter 827. The top portion may have a thickness of about 3 millimeters. At the bottom of the lower portion of module 860 may be a layer or portion 856 of wireless communication electronics for data transfer and control of micro analyzer 800. This layer 856 may have a thickness of about 3 millimeters and have about the same lateral area as that of the module 860. Below layer 856 may be a portion for a H₂ generator battery system 857 or power pack or holder having a thickness of about 3.8 millimeters thick and about the same lateral area as that of module 860. The generator system 857 may be thicker (e.g., 10 millimeters) or thinner depending on the power needed for the analyzer 800, the desired time between recharges and the technology (e.g., lithium) of the battery. If all of the portions, including the wireless electronics and the battery, are adhered together, the total thickness may be about 1.38 centimeters resulting in a volume of about 3.6 cm³. The dimensions may be relaxed if exceptional compactness is not needed. In the latter case, the top portion with the pumps may have an area less than 25 square centimeters and a thickness less than 10 millimeters. The portion 856 for wireless communication may have an area less than 25 square centimeters and a thickness less than 10 millimeters. The lower portion with controller 835 may have an area less than 25 square centimeters and a thickness of less than 10 millimeters. The middle portion 854 may have an area less than 25 square centimeters and a thickness less than 10 millimeters. The portion for the H₂ generator system 857 or its holder may have an area less than 25 square centimeters. The above dimensions may be alternatively less than 2.5 square centimeters in lieu of 25 square centimeters.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

1. A generator system comprising:
a hydrogen gas generator;
an electric power generator connected to the hydrogen gas generator; and
a device connected to the hydrogen gas generator and the electric power generator.

2. The system of claim 1, wherein:
the hydrogen gas generator may provide hydrogen as a fuel to the electric power generator;
the hydrogen gas generator may provide hydrogen to the device; and
the electric power generator may provide electric power to the device.

3. The system of claim 2, wherein the device is selected from a group consisting of a flame ionization detector, a gas chromatograph, a gas calibration device, and any combination thereof.

4. The system of claim 2, wherein the hydrogen gas generator comprises at least one hydrogen-containing chemical.

5. The system of claim 4, wherein the at least one hydrogen-containing chemical is selected from a group consisting of water and metal hydrides.

6. The system of claim 2, wherein the device may use hydrogen gas from the hydrogen gas generator in a non-destructive manner, and return the hydrogen gas to the hydrogen gas generator.

7. The system of claim 2, wherein the device may use hydrogen gas from the hydrogen gas generator in a non-destructive manner and forward the hydrogen gas to the electric power generator as a fuel to generate electrical power.

8. The system of claim 7, further comprising an electrical power storage mechanism.

9. The system of claim 8, wherein the electrical power storage mechanism is selected form a group consisting of a capacitor, a super capacitor, a rechargeable battery, and any combination thereof.

10. The system of claim 7, wherein:
the fuel cell may generate water which is forwarded to the hydrogen gas generator; and
the hydrogen gas generator may use the water to generate hydrogen gas.

11. The system of claim 8 further comprising a controller connected to the electrical power storage mechanism and the electrical power generator.

12. The system of claim 11, further comprising:
a power sensor connected to an output of the electrical power generator and to the controller; and
a hydrogen flow sensor connected to a hydrogen input to the electrical power generator and to the controller.

13. A generation system comprising:
a hydrogen gas generator;
a fuel cell connected to the hydrogen gas generator; and
a fluid analyzer connected to the hydrogen gas generator and the fuel cell.

14. The system of claim 13, wherein:
the hydrogen gas generator provides hydrogen gas to the fluid analyzer; and
the fuel cell provides electrical power to the fluid analyzer.

15. The system of claim 14, wherein the fluid analyzer comprises:
a channel; and
a plurality of heaters situated along the channel; and
wherein:
the plurality of heaters may turn on in a sequential manner to continually heat a portion of a sample fluid as it moves through the channel; and
the plurality of heaters may provide a heat pulse that moves along the channel at a velocity about the same as a velocity of the portion of the sample fluid moving through the channel.

16. The system of claim 15, wherein the plurality of heaters cumulatively heat the portion of the sample fluid.

17. The system of claim 15, further comprising a preconcentrator connected to the fluid analyzer.

18. A generator system comprising:
a container having a diaphragm covering a first end, and a second end;
a valve situated in and about the middle or the container and connected to the diaphragm, wherein the valve approximately divides the container into a first chamber proximate to the diaphragm and a second chamber proximate to the second end;
a fuel cell situated in the second portion of the container; and
the holder for fuel situated in the first chamber.

19. The system of claim 18, further comprising a membrane in the second chamber proximate to the second end and resulting in a first and second subchamber in the second chamber, wherein the second subchamber is proximate to the second end.

20. The system of claim 19, wherein:
the second subchamber is for receiving water generated by the fuel cell and for containing water; and
the second membrane is for permitting water vapor to enter the first subchamber from the second subchamber.

21. The system of claim 20, wherein:
the valve may open for permitting water vapor to enter the first chamber and react with fuel in the holder and generate hydrogen to enter the second chamber via the valve and be fuel for the fuel cell to generate electricity; and
the valve may close for preventing water vapor from entering the first chamber and for preventing hydrogen from entering the second chamber.

22. The system of claim 21, further comprising a device that may utilize hydrogen and electricity for operation.

23. The system of claim 22, wherein the device may receive hydrogen from the container via a port and electricity from the fuel cell.

24. The system of claim 23, wherein the device may non-destructively utilize the hydrogen and return the hydrogen to the container.

25. The system of claim 24, wherein the device is selected from a group consisting of a flame detector, a fluid chromatograph, and a fluid chromatograph, and a fluid calibration mechanism.

26. A method for generating hydrogen and electricity for a device comprising:
1) providing water;
2) converting the water into a vapor;
3) combining the vapor with a fuel to generate hydrogen;
4) feeding the hydrogen to a device;
5) forwarding the hydrogen from the device to a fuel cell;
6) generating electricity with the fuel cell from the hydrogen;
7) providing electricity to a storage system8) providing the electricity to the device;
9) converting water generated by the fuel cell into a vapor; and
10) repeating method actions 3-9 in any order as needed.

27. The method of claim 26, wherein the device is selected from a group consisting of a flame detector, a fluid chromatograph, and a fluid calibration mechanism.

28. The method of claim 26, wherein the fuel to generate hydrogen is LiAlH₄.
